(19) United States
(12) Patent Application Publication
(10) Pub. No.: US 2018/0347967 A1
(43) Pub. Date: Dec. 6, 2018

(54) METHOD AND APPARATUS FOR GENERATING A RANDOM CODING PATTERN FOR CODING STRUCTURED LIGHT

(71) Applicant: RGBDsense Information Technology Ltd., Ningbo (CN)

(72) Inventors: Chenyang GE, Xi'an (CN); Huimin Yao, Xi'an (CN); Yanhui ZHOU, Xi'an (CN)

(73) Assignee: RGBDsense Information Technology Ltd., Ningbo (CN)

(21) Appl. No.: 15/664,258

(22) Filed: Jul. 31, 2017

(30) Foreign Application Priority Data
Jun. 1, 2017 (CN) 2017104058683

(51) Int. Cl. G01B 11/22; H04N 13/02; G06K 9/48; G06F 17/18

(52) U.S. Cl. CPC G01B 11/22; G06F 17/18; G06K 9/48; H04N 13/0253

(57) ABSTRACT

The present disclosure discloses a method of generating a random coded pattern for coding structured light. According to the method, under a certain distribution rule, coding primitives are added one by one using a random probability distribution map, thereby generating a random coded pattern satisfying a distribution requirement of window uniqueness; the random coded pattern may be used independently as a structured light encoded pattern or may be spliced and expanded from basic image elements as the structured light coded pattern. The structured light coded pattern obtained from the method is projected by a projecting device according to a certain field of angle, which may perform spatial coding and feature calibration to the three-dimensional space or a target object, for depth identification. The present disclosure also discloses an apparatus for generating a random coded pattern for coding structured light. The random coded pattern generated by the method or apparatus of the present disclosure has a high randomness and supports a plurality of coding primitives of different shape sizes, such that the identification issues of monocular, binocular or multi-view matching during a depth decoding process may be solved.

### FIELD OF THE INVENTION

The present disclosure relates to a 3D depth camera, computer vision, depth perception, and a three-dimensional rebuilding technology, and specifically relates to a method and apparatus for coding structured light that is projected in an active stereovision for marking a space, and more particularly to a method and an apparatus generating a random coded pattern for coding structured light.

### BACKGROUND OF THE INVENTION

Vision is the most direct and effective approach for mankind to perceive external environment. The purpose of studying computer vision is to expect that computers can perceive various states (e.g., color, shape, surface textual information of an object, environmental position of the object, and movement of the object, etc.) in an environment in a way like what the human vision does. However, in application fields of computer vision, the information that may be easily parsed out by mankind and animals from one or more images possibly goes wrong with the computer vision. One technology of capturing distance information in a scene is referred to as a depth perception technology, which may facilitate a computer to better perceive a surrounding environment and plays a critical role in fields like virtual reality, three-dimensional rebuilding, human-machine interaction, industrial automation, robot navigation, and medical imaging. For example, in the field of consumer electronics, the depth perception technology can facilitate an electronic product to recognize different actions of human beings to thereby make corresponding reactions, which brings a fresh, convenient and smart experience to users and thus plays a significant role in enhancing the interaction capability and smart level of the electronic product. In the industrial field, a high-precision and high-resolution depth information technology is urgently needed in sectors such as 3D printing, robot manipulation, and etc.

The depth perception technologies may be categorized into an active type and a passive type based on whether an active light source exists in a depth perception device. The active-type depth perception technology captures a pattern projected by a projector on a spatial object using an image sensor and then obtains spatial position information of the object by analyzing and processing the pattern (e.g., the approach of structured light coding, the approach of ToF (Time of Flight)). The active-type depth perception technology is characterized in that the depth information is stable, reliable, and less affected by ambient light; besides, its matching process is not affected by textual information of the object. One of the core content of a structured light coding-based depth perception method is to develop a coded pattern projecting device, and the coded pattern as designed will directly affect the computational complexity of depth decoding as well as the precision and spatial resolution of the depth information; besides, it also has a relatively large impact on the ant-noise and anti-distortion capability during the decoding process as well as the depth decoding capability in a complex scene.

### SUMMARY OF THE INVENTION

A method and an apparatus for generating a random coded pattern for coding a structured light provided by the present disclosure at least can solve part of the above problems, which facilitates depth recognition by generating a random coded pattern satisfying a requirement of performing high-performance depth decoding in a complex scene, the random coded pattern being projected by a projecting device on a three-dimensional space or a target object for spatial coding and feature calibration.

A method of generating a random coded pattern for coding structured light comprises steps of:

S100. determining a resolution of a random coded pattern to obtain a random probability distribution map of a same resolution size;

S200. obtaining a position of a point with the largest probability value in the random probability distribution map;

S300. marking the position as a central point position of a coding primitive in the random coded pattern and the random probability distribution map;

S400. marking coding primitives in the random probability distribution map according to a shape and size of the coding primitive;

marking points that cannot be other coding primitives surrounding the coding primitives in the random probability distribution map according to a distribution rule of the coding primitives;

S500. determining whether all points in the random probability distribution map are completely marked; if not yet, performing step S600;

S600. obtaining a position of a point with a largest probability value from among unmarked points in the random probability distribution map, and returning to step S300.

For the method aforementioned, if it is determined that all points in the random probability distribution map have been completely marked in the step S500, the following steps are performed:

S700. determining whether a structured light coded pattern satisfies a requirement of window uniqueness distribution, the structured light coded pattern being constituted by random coded patterns; in the case of not satisfying the requirement, performing step S800;

S800. determining a re-marked zone and re-generating a random probability distribution map that has a same size as the re-marked zone; and returning to step S200.

For the aforementioned or the following method, a shape of the coding primitive includes a feature point, a square, a circle, an oblique strip, an S shape, or any other shape consisting of a plurality of feature points.

For the aforementioned or the following method, the step S700 further comprises a step before the determining:

S701. splicing and expanding the random coded pattern as a basic image element.

For the aforementioned or the following method, the splicing and expanding includes a regular array manner, a staggered array manner, and an array rotating manner.

For the aforementioned or the following method, probability values of points in the random probability distribution map range between (0, 1).

For the aforementioned or the following method, in the steps S300-S600, a probability mark map instead of the random probability distribution map is used to mark; a resolution size of the probability mark map is identical to the random probability distribution map, where an initial value of each point is identical and not 0; when marking a point in the probability mark map, a value of the point is made 0;

Moreover, the step S600 may be replaced by the following step: S600′: replacing the random probability distribution map with a resultant map from point-to-point multiplication of the probability mark map and the random probability distribution map marked in step S400, and then returning to step S200.

For the aforementioned or the following method, after marking the random coded pattern in the step S300, the method further comprises a step of:

marking coding primitives in the random coded pattern using the marked point according to a shape and size of the coding primitive.

For the aforementioned method, a distribution rule of the coding primitives includes one or a combination of the following rules: satisfying an isolation principle, and satisfying a spacing requirement between coding primitives.

In another aspect, the present disclosure provides an apparatus for generating a random coded pattern for coding structured light, the apparatus comprising a pattern generating module and a projecting module;

the pattern generating module generates a random coded pattern using any method aforementioned; and the projecting module determines a corresponding light-emitting source according to a coding primitive in the random coded pattern.

Compared with the prior art:

the method and apparatus in the present disclosure may quickly and accurately generate a random coded pattern satisfying a requirement of performing high-performance depth decoding in a complex scene; and the coding primitives constituting the random coded pattern have a good stochastic characteristic while satisfy a window unique identification characteristic, i.e., when the random coded pattern is projected, by the projecting module, on a three-dimensional space or a target object according to a certain angle of view, each feature point in the projected three-dimensional space or on a surface of the projected target object may be uniquely identified within a certain range, wherein each coding primitive corresponds to one or more feature points; in this way, the identification issues of monocular, binocular or multi-view matching during a depth decoding process may be solved.

### BRIEF DESCRIPTION OF THE ACCOMPANYING DRAWINGS

FIG. 1 is a general flow diagram of generating a random coded pattern according to the present disclosure;

FIG. 2(a) is a schematic diagram of an embodiment of coding a primitive pattern according to the present disclosure;

FIG. 2(b) is a schematic diagram of another embodiment of a coding primitive pattern according to the present disclosure;

FIG. 2(c) is a schematic diagram of a further embodiment of a coding primitive pattern according to the present disclosure;

FIG. 2(d) is a schematic diagram of a still further embodiment of a coding primitive pattern according to the present disclosure;

FIG. 3(a) is a schematic diagram of an embodiment of a random probability distribution map according to the present disclosure;

FIG. 3(b) is a schematic diagram of an embodiment of a probability mark map according to the present disclosure;

FIG. 4(a) is a probability mark map before generating a coding primitive according to the present disclosure;

FIG. 4(b) shows changes of position probability mark values of a coding primitive generated according to the present disclosure;

FIG. 4(c) shows an embodiment design of changes of probability mark values surrounding the coding primitive according to the present disclosure;

FIG. 4(d) shows another embodiment design of changes of probability mark values surrounding the coding primitive according to the present disclosure;

FIGS. 5A-1 to 5A-4 show changes of a random coded pattern during a process of generating coding primitives one by one according to the present disclosure;

FIGS. 5B-1 to 5B-4 show changes of a probability mark map during a process of generating coding primitives one by one according to the present disclosure;

FIG. 6 shows another embodiment design of generating a random coded pattern with FIG. 3(d) as the coding primitive according to the present disclosure;

FIG. 7 shows an embodiment of splicing and expanding in a staggered array manner with the coded pattern as a basic image element according to the present disclosure;

FIG. 8A shows an embodiment before splicing and expanding in a rotating array manner with the coded pattern as a basic image element according to the present disclosure;

FIG. 8B shows an embodiment after splicing and expanding in a rotating array manner with the coded pattern as a basic image element according to the present disclosure.

### DETAILED DESCRIPTION OF THE PREFERRED EMBODIMENTS

Hereinafter, the present disclosure will be described in detail with reference to the accompanying drawings.

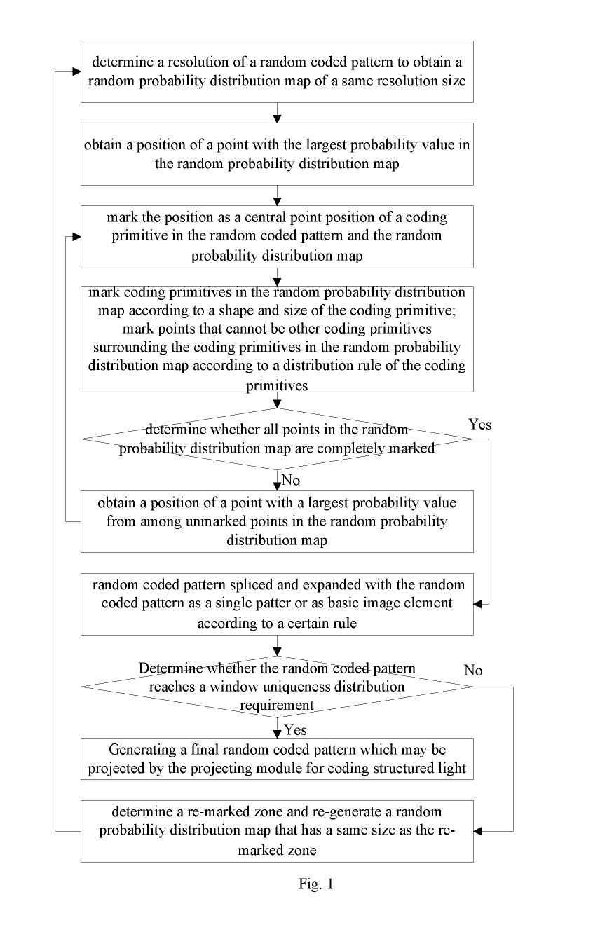

In an embodiment, a random coded pattern may be generated using a schematic flow diagram of FIG. 1. Coding primitives of the random coded pattern have a good stochastic characteristic while satisfy a window unique identification characteristic, i.e., when the random coded pattern is projected, by the projecting module, on a three-dimensional space or a target object according to a certain angle of view, each feature point in the projected three-dimensional space or on a surface of the projected target object may be uniquely identified within a certain range, wherein each coding primitive corresponds to one or more feature points; in this way, the identification issues of monocular, binocular or multi-view matching during a depth decoding process may be solved. The flow diagram comprises the following steps:

S100. determining a resolution of a random coded pattern to obtain a random probability distribution map of a same resolution size;

S200. obtaining a position of a point with the largest probability value in the random probability distribution map;

S300. marking the position as a central point position of a coding primitive in the random coded pattern and the random probability distribution map;

S400. marking coding primitives in the random probability distribution map according to a shape and size of the coding primitive;

marking points that cannot be other coding primitives surrounding the coding primitives in the random probability distribution map according to a distribution rule of the coding primitives;

S500. determining whether all points in the random probability distribution map are completely marked; if not yet, performing step S600;

S600. obtaining a position of a point with a largest probability value from among unmarked points in the random probability distribution map, and returning to step S300.

S700. determining whether a structured light coded pattern satisfies a requirement of window uniqueness distribution, the structured light coded pattern being constituted by random coded patterns; in the case of not satisfying the requirement, performing step S800;

S800. determining a re-marked zone and re-generating a random probability distribution map that has a same size as the re-marked zone; and returning to step S200.

In this embodiment, the random probability distribution map has a same resolution as the random coded pattern, and positions of points in the random probability distribution map are identical to the positions of points in the random coded pattern, a value of a point in the random probability distribution map indicating an appearing probability of a central point of the coding primitive at the position of the point. Values of the points in the random probability distribution map are random numbers generated by a random array generating function inherent in a programming software or generated by a customized random array generator, which may be any decimals ranging between 0-1. Central points of the coding primitives in the random coded pattern are determined according to random numbers in the random probability distribution map. In order to guarantee uniqueness of the position of the coding primitive generated in each selection, values of the points in the random probability distribution map are different from one another. For the values of points in each map, specifically, for example, the initial values of the points are all 0, and the initial values of the points in the random probability distribution map correspond to random numbers ranging from 0-1. The values of the points in each map are used for marking, such that they may not be limited to what are listed above. For the random coded pattern whose initial values are all 0, in order to find corresponding positions during marking, the pixel values of the positions are changed from 0 to 1.

The resolution of the randomly encoded pattern may be set dependent on the requirements of making the coded pattern projecting module and a ranging scope of a 3D depth camera, where the initial value of each pixel is uniformly 0. The coded pattern projecting module is fabricated in association with the shape, size, number, and distribution restraining rule of the coding primitives. In the random coded pattern, when the coding primitives are distributed in identical numbers, the larger the pixel size representing a coding primitive, the greater the distance between coding primitives is, and therefore the larger the resolution of the designed random coded pattern is. The ranging scope of the 3D depth camera also affects the resolution size of the coded pattern, and meanwhile it is required that the designed random coded pattern must guarantee a minimum resolution size of window uniqueness. For example, if a searching scope required by the ranging scope is 20 pixels respectively thereabove and thereunder, and 200 pixels respectively to the left and the right, the resolution of the randomly encoded pattern should not be lower than 41×401, and in the scope, a window of a certain size consisting of coding primitives must satisfy the uniqueness requirement.

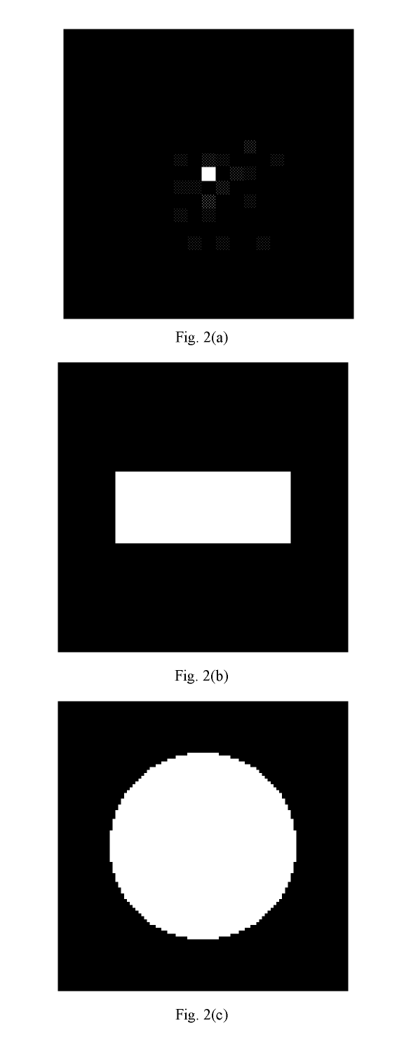

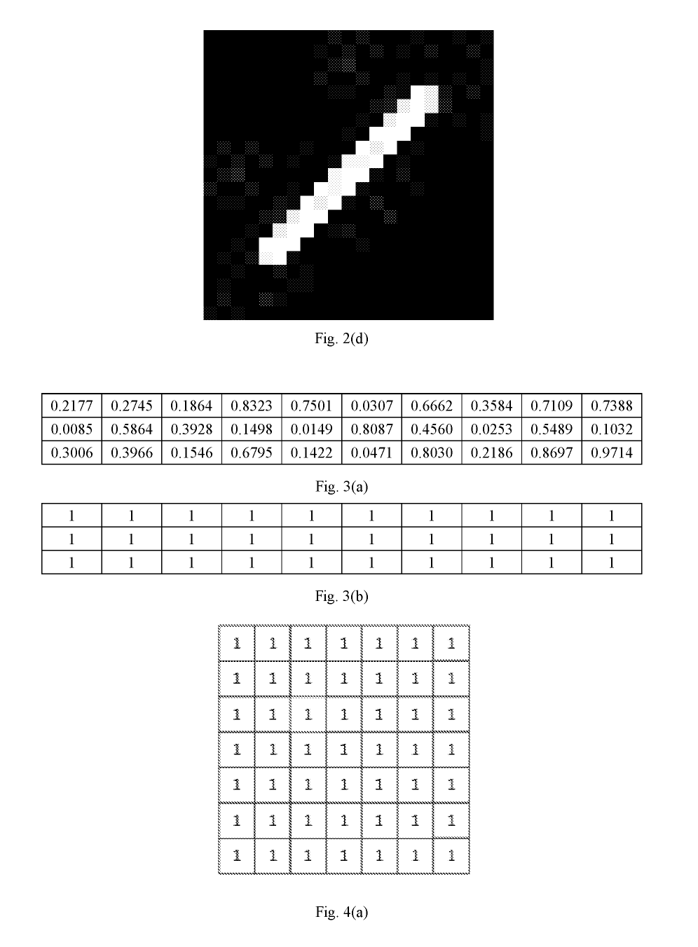

The number of coding primitives may be plural in a random coded pattern; by controlling the distribution rule of the coding primitives, the number of coding primitives may be adjusted and then the density of coding primitives may be controlled. When the number of coding primitives is plural, after the coding primitives are generated at step S400, points that surround the marked coding primitive but cannot act as other coding primitives are marked in the random probability distribution map; these points may highlight the coding primitive shape. The coding primitives may be of any shape consisting of a plurality of pixels, such as a dot, a line segment, a circle, a rectangle, an oblique strip, a parallelogram, a diamond, a trapezoid, a triangle, an S shape, etc. FIGS. 2(a)-2(d) illustrate a plurality of shapes of coding primitives. The size of coding primitives may be represented by one or more pixel points dependent on situations. Distribution among coding primitives complies with a certain distribution rule such that after the random coded pattern is projected by the projecting module, each coding primitive in the projected three-dimensional space or on a surface of the projected target object may correspond to one or more feature points of the three-dimensional space or on the surface of the target object, such that each feature point may be uniquely identified within a certain range, thereby solving identification issues of monocular, binocular or multi-view matching during a depth decoding process.

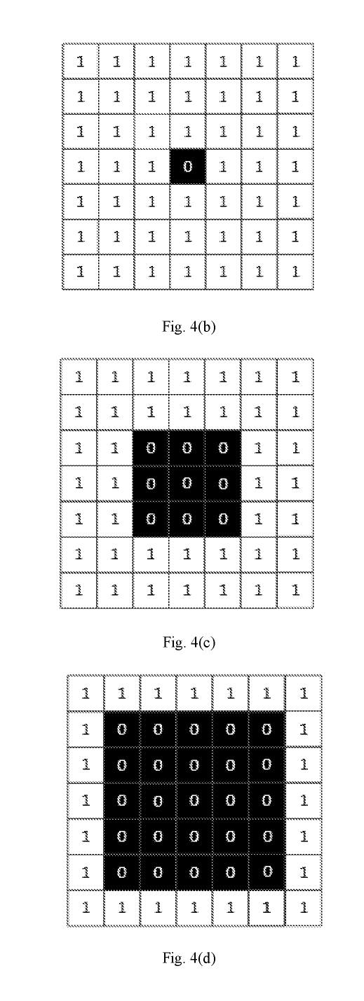

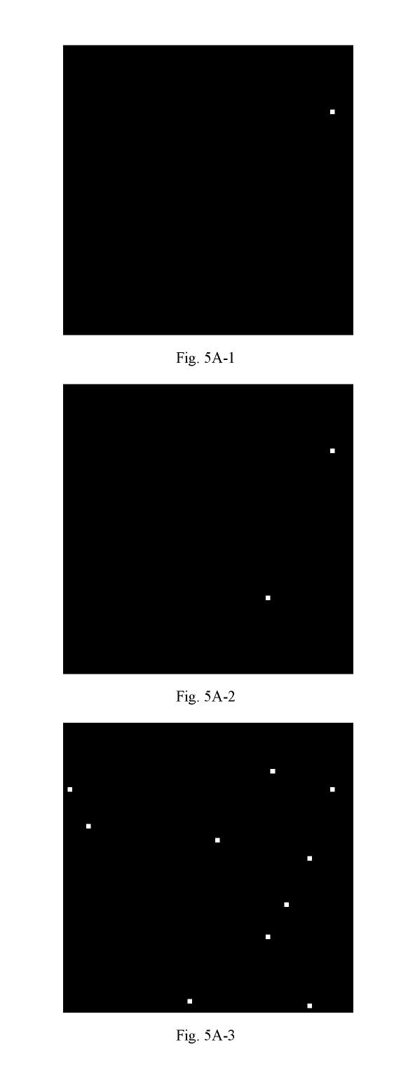

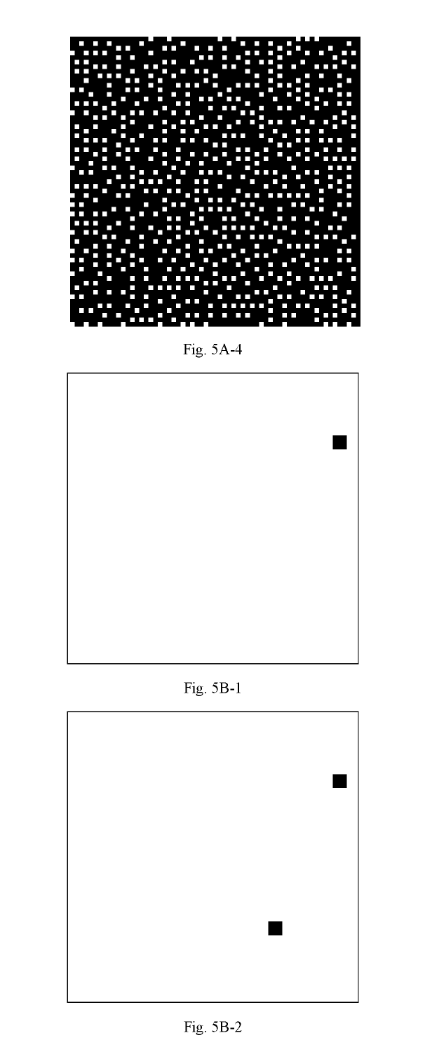

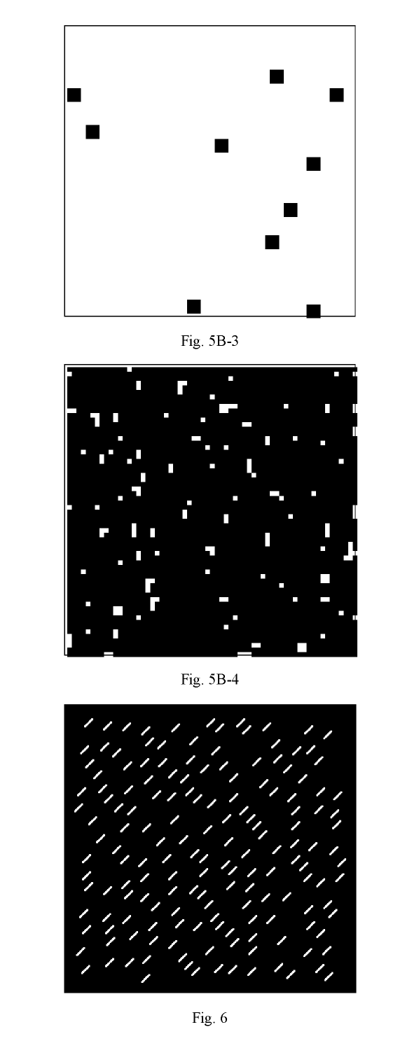

FIGS. 4(a)-4(b) illustrate a distribution rule of coding primitives when a coding primitive is a single pixel point. In order to ensure an isolation principle of coding primitives, with a present position as a central point of the coding primitive, no other coding primitives will be generated in its eight neighboring domains, and the probability mark map corresponding to the coding primitive will be changed to FIG. 4(c); under some constraints (e.g., according to the requirement of manufacturing process, it is not only required that the coding primitive should ensure its isolation principle, but also its spacing with other coding primitive should be greater than two pixels), the probability mark map corresponding to the coding primitive will be changed to FIG. 4(d); and as such, a suitable spacing between coding primitives should be more than two or more pixels. However, the distribution rule in the present disclosure is not limited to the situations in FIG. 4(c) and FIG. 4(d); the distribution rule of the coding primitives may be adjusted according to the shape, size, and distribution sparsity of the coding primitives in conjunction with practical application rules. FIG. 5A-1, FIG. 5A-2, FIG. 5A-3, and FIG. 5A-4 provide a process of generating a random coded pattern with one pixel point as a light source and at least one pixel being spaced between light sources, and a changing process of the probability mark map during the generating process. FIGS. 5B-1, 5B-2, 5B-3, and 5B-4 provide a changing process of a random coded pattern generated using a square coded primitive. It is seen from the last image of FIG. 5B-4 that the corresponding probability mark map is not all 0; therefore, the density of the coding primitive has not reached the maximum value. FIG. 6 shows a design result of generating a random coded pattern with FIG. 2(d) as the central point of the coding primitive, illustrating that the coding primitive of the present disclosure is not limited to a round dot, which may be a rectangle, a square, and an oblique strip, etc.

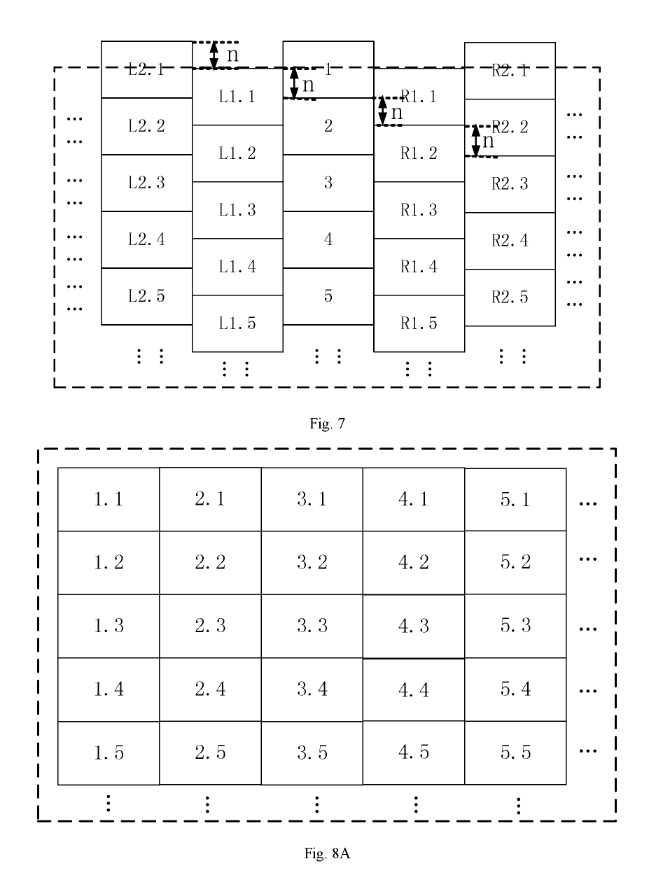

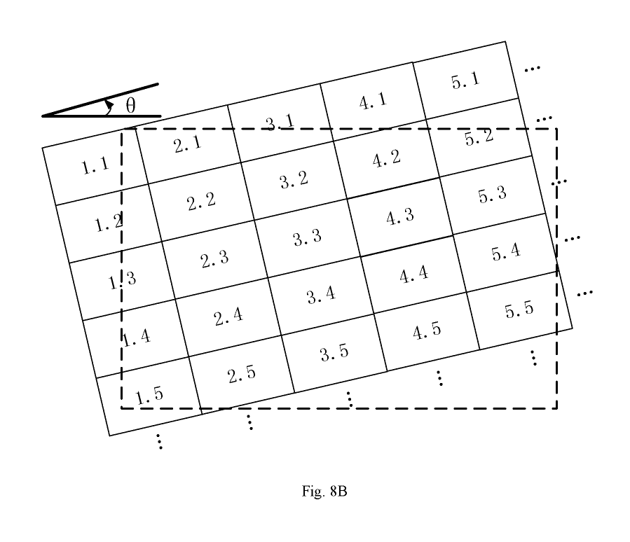

The structured light coded pattern may be a single image generated according to the method above, or may be spliced and expanded with the single pattern generated above as a basic image element according to a certain rule. The basic image element refers to a random coded pattern containing a certain number of coding primitives with a relatively low resolution; due to the limitations of manufacturing techniques and volume restraints of the projecting module, only a smaller resolution can be adopted. A high-resolution random coded pattern is expanded by splicing the basic image elements. The splicing and expanding method of basic image elements includes a regular array manner, a staggered array manner, and an array rotating manner, etc.; the size of the expanded random coded pattern may be voluntarily set. In the regular array manner, the basic image elements are regularly arranged according to horizontal and vertical directions, which are spliced into a randomly coded pattern with K×L blocks, where K and L are positive integers, which may be identical or different. The staggered array manner, as illustrated in FIG. 7 where each block indicates a basic image element, means the basic image elements in each column and the basic image elements of the column that is laterally in its immediate adjacency may be staggered in the vertical direction by a certain number of lines, e.g., staggered by a half of the height of the basic image elements or staggered by n rows as set (where n is a positive integer); the basic image elements may be arranged evenly between rows and between columns, or may be arranged unevenly, e.g., dense in the middle while sparse in the surrounding or sparse in the middle but dense in the surrounding. As to the array rotating manner, FIG. 8A is a basic image element array before the rotation; FIG. 8B is a basic image element array after the rotation, which may rotate by a θ angle in a clockwise direction or a counterclockwise direction, and its angle may be set according to the subsequent window uniqueness identification rule and the search scope required by the ranging scope.

In the three-dimensional depth perception technology based on structured light coding, the output structured light coded pattern has to satisfy the window uniqueness, i.e., the characteristic requirement of window uniqueness identification: in a certain search scope of the structured light coded pattern (e.g., obtaining a coded pattern block with a range of r×v arrays, where r and v are positive integers), if the coded pattern block consists of k1×k2 matrixes (which may include a plurality of coding primitives, where k1 and k2 are both positive integers), the coded pattern block is unique if the coded pattern block only appears once, the coded pattern block is unique so as to be distinguished from other coded pattern blocks of the same size. The size of the window is k1×k2, i.e., the size of the coded pattern block. The present disclosure has no limitation regarding the size of the coded pattern block, i.e., the size of the coded pattern block is adjustable. The larger the window, the easier the window uniqueness is satisfied; the smaller the window, the more detailed the obtained depth map is.

Based on the window uniqueness requirement above, the compulsory precondition for outputting the structured light coded pattern (regardless of whether it consists of a single random coded pattern or it is spliced and expanded from a plurality of random coded patterns) is that the requirement of window uniqueness distribution should be satisfied. For a generated random coded pattern, if it cannot satisfy the window uniqueness distribution, the random coded pattern may be re-generated locally or entirely so as to cause it to satisfy the window uniqueness requirement. Here, the “locally” may refer to one local part or several local parts; the one or more local parts may be artificially designated or determined randomly. The present disclosure does not limit the size, shape, and position of the re-marked zone. Therefore, the present disclosure is not limited to the aforementioned implementation steps. Any modification and improvement within the spirit and scope of the present disclosure should be included in the scope of the claims.

For a random coded pattern with the initial values being all 0, pixel value 1 in the outputted random coded pattern corresponds to a central point of respective coding primitive. In order to obtain a complete random coded pattern, after the random coded pattern is marked in step S300, the following step may be executed: marking coding primitives in the random coded pattern using the marked points according to the shape and size of coding primitives. In this way, the random coded pattern finally outputted in step S700 has complete coding primitives, and the coding primitives have a certain distribution rule; the pattern may be applied to encode the structured light through a projecting module.

In one embodiment, for the steps S300, S400, and S500, it is the probability mark map instead of the random probability distribution that is marked. The resolution of the probability mark map is identical to the random probability map, the initial value of each point being identical and not 0. Upon marking points in the probability mark map, the values of the points are made 0. For generating a structured light random coded pattern with a resolution size of 3×10, FIG. 3(a) schematically illustrates a random probability distribution map of the corresponding 3×10 size; FIG. 3(b) schematically illustrates a corresponding probability mark map in which the initial values of all points are set to 1.

In the case of marking using the probability mark map, steps S300-S600 are changed to:

S300′. marking the position as a central point position of a coding primitive in the random coded pattern and the random probability distribution map, and changing the probability mark value corresponding to the position from 1 to 0.

S400′. marking coding primitives in the random probability distribution map according to a shape and size of the coding primitive; and meanwhile marking points that cannot be other coding primitives surrounding the coding primitives in the random probability distribution map according to a distribution rule of the coding primitives;

S500′. determining whether all points in the random probability distribution map are completely marked; if not yet, performing step S600;

Correspondingly, the step S600 in the step S500′ actually refers to the step S600′ below:

S600′: point-to-point multiplying the random probability distribution map with the marked probability mark map in step S400′ and replacing the random probability distribution map with the resultant map, and then returning to step S200. Through the point-to-point multiplication, positions where coding primitives will not be generated any more are excluded.

In another embodiment, an apparatus for generating a random coded pattern for coding structured light is provided to generate the random coded pattern and project the generated random coded pattern, the apparatus comprises a random coded pattern using any method above; the projecting module determines corresponding light-emitting sources according to the coding primitives in the structured light random coded pattern, wherein the coding primitives may one-to-one correspond to the light-emitting sources. The projecting module projects the random coded pattern onto a three-dimensional space or a target object to implement feature marking of the three-dimensional space or the target object; each feature point on the surface of the projected three-dimensional space or target object may be uniquely identified within a certain range, wherein each coding primitive corresponds to one or more feature points on the three-dimensional space or the target object, which facilitates depth identification. The projecting module is not limited to a laser projecting module, an LED/LCD projector, a DLP, an MEMS projector, as well as other stationary or mobile projection devices. The supported projection pattern optical waves include optical waves of various wave lengths, e.g., an X-ray, an ultraviolet ray, a visible light, and an infrared ray, etc. Its light-emitting sources may be various kinds of laser sources such as VECSEL, LD, LED, and etc.

The present disclosure is not limited to the preceding embodiments. Therefore, modifications and improvements without departing from the spirit and scope of the present disclosure should be included in the scope of the claims.

1. A method of generating a random coded pattern for coding structured light comprises steps of:
S100. determining a resolution of a random coded pattern to obtain a random probability distribution map of a same resolution size;
S200. obtaining a position of a point with the largest probability value in the random probability distribution map;
S300. marking the position as a central point position of a coding primitive in the random coded pattern and the random probability distribution map;
S400. marking coding primitives in the random probability distribution map according to a shape and size of the coding primitive;
marking points that cannot be other coding primitives surrounding the coding primitives in the random probability distribution map according to a distribution rule of the coding primitives;
S500. determining whether all points in the random probability distribution map are completely marked; if not yet, performing step S600;
S600. obtaining a position of a point with a largest probability value from among unmarked points in the random probability distribution map, and returning to step S300.

2. The method according to claim 1, characterized in that if it is determined that all points in the random probability distribution map have been completely marked in the step S500, the following steps are performed:
S700. determining whether a structured light coded pattern satisfies a requirement of window uniqueness distribution,
the structured light coded pattern being constituted by random coded patterns; in the case of not satisfying the requirement, performing step S800;
S800. determining a re-marked zone and re-generating a random probability distribution map that has a same size as the re-marked zone; and returning to step S200.

3. The method according to claim 1, characterized in that a shape of the coding primitive includes a feature point, a square, a circle, an oblique strip, an S shape, or any other shape consisting of a plurality of feature points.

4. The method according to claim 2, characterized in that the step S700 further comprises a step before the determining:
S701. splicing and expanding the random coded pattern as a basic image element.

5. The method according to claim 4, characterized in that the splicing and expanding includes a regular array manner, a staggered array manner, and an array rotating manner.

6. The method according to claim 1, characterized in that probability values of points in the random probability distribution map range between (0, 1).

7. The method according to claim 1, characterized in that
in the steps S300-S600, a probability mark map instead of the random probability distribution map is used to mark;
a resolution size of the probability mark map is identical to the random probability distribution map, where an initial value of each point is identical and not 0;
when marking a point in the probability mark map, a value of the point is made 0;
further, the step S600 may be replaced by the following step: S600′:
replacing the random probability distribution map with a resultant map from point-to-point multiplication of the probability mark map and the random probability distribution map marked in step S400, and then returning to step S200.

8. The method according to claim 1, characterized in that after marking the random coded pattern in the step S300, the method further comprises a step of:
marking coding primitives in the random coded pattern using the marked point according to a shape and size of the coding primitive.

9. The method according to claim 1, characterized in that a distribution rule of the coding primitives includes one or a combination of the following rules: satisfying an isolation principle, and satisfying a spacing requirement between coding primitives.

10. An apparatus for generating a random coded pattern for coding structured light, the apparatus comprising a pattern generating module and a projecting module;
the pattern generating module generates a random coded pattern according to claim 1; and
the projecting module determines a corresponding light-emitting source according to a coding primitive in the random coded pattern.

11. An apparatus for generating a random coded pattern for coding structured light, the apparatus comprising a pattern generating module and a projecting module;
the pattern generating module generates a random coded pattern according to claim 2; and
the projecting module determines a corresponding light-emitting source according to a coding primitive in the random coded pattern.

12. An apparatus for generating a random coded pattern for coding structured light, the apparatus comprising a pattern generating module and a projecting module;
the pattern generating module generates a random coded pattern according to claim 3; and
the projecting module determines a corresponding light-emitting source according to a coding primitive in the random coded pattern.

13. An apparatus for generating a random coded pattern for coding structured light, the apparatus comprising a pattern generating module and a projecting module;
the pattern generating module generates a random coded pattern according to claim 4; and
the projecting module determines a corresponding light-emitting source according to a coding primitive in the random coded pattern.

14. An apparatus for generating a random coded pattern for coding structured light, the apparatus comprising a pattern generating module and a projecting module;
the pattern generating module generates a random coded pattern according to claim 5; and
the projecting module determines a corresponding light-emitting source according to a coding primitive in the random coded pattern.

15. An apparatus for generating a random coded pattern for coding structured light, the apparatus comprising a pattern generating module and a projecting module;
the pattern generating module generates a random coded pattern according to claim 6; and the projecting module determines a corresponding light-emitting source according to a coding primitive in the random coded pattern.

16. An apparatus for generating a random coded pattern for coding structured light, the apparatus comprising a pattern generating module and a projecting module;
the pattern generating module generates a random coded pattern according to claim 7; and the projecting module determines a corresponding light-emitting source according to a coding primitive in the random coded pattern.

17. An apparatus for generating a random coded pattern for coding structured light, the apparatus comprising a pattern generating module and a projecting module;
the pattern generating module generates a random coded pattern according to claim 8; and the projecting module determines a corresponding light-emitting source according to a coding primitive in the random coded pattern.

18. An apparatus for generating a random coded pattern for coding structured light, the apparatus comprising a pattern generating module and a projecting module;
the pattern generating module generates a random coded pattern according to claim 9; and the projecting module determines a corresponding light-emitting source according to a coding primitive in the random coded pattern.
